(19) United States
(12) Patent Application Publication
(10) Pub. No.: US 2026/0165358 A1
(43) Pub. Date: Jun. 18, 2026

(54) PLANT PROTEIN-BASED CONFECTIONARY MASS

(71) Applicant: FrieslandCampina Nederland B.V., Amersfoort (NL)

(72) Inventors: Aart Cornelis Alting, Ede (NL); Francisca Elisabeth Ellen Oosterveen, Driel (NL); Karlijn Johanna Margaretha Hol, Veenendaal (NL)

(21) Appl. No.: 19/126,625

(22) PCT Filed: Nov. 1, 2023
(86) PCT No.: PCT/EP2023/080470

§ 371 Date: May 1, 2025

(30) Foreign Application Priority Data
Nov. 3, 2022 (EP) 22205319.1
Nov. 3, 2022 (EP) 22205322.5
Nov. 3, 2022 (EP) 22205323.3

(51) Int. Cl. A23L 33/19; A23K 40/25; A23L 33/115; A23L 33/12; A23L 33/18; A23L 33/185

(52) U.S. Cl. CPC A23L 33/19; A23K 40/25; A23L 33/115; A23L 33/12; A23L 33/18; A23L 33/185; A23V 2002/00; A23V 2250/54246

(57) ABSTRACT

The invention relates to a confectionary mass comprising a plant protein concentrate or hydroly sate and microparticulated whey protein. This allows for the preparation of plant-based high protein nutritional bars with a pleasant texture and taste.

The present invention relates to a plant protein-based confectionary mass that is rich in protein.

Confectionary products such as food bars are made from confectionary masses, i.e. substances that can be subjected to a shaping process, such as rolling, extruding, depositing and removing from refrigerated drums, pressing, moulding, and the like. These masses generally are non-fluid but deformable at ambient temperature, at least until after having been shaped into a desired form, such as a bar. They typically have a dough-like consistency. Accordingly, they are also referred to in the art as ‘doughs’. After having been shaped, the consistency of the mass may change.

There is a current trend towards high protein food products; especially for elderly, sportsmen, and people with an active lifestyle. Commercial products supporting this trend include various high protein shakes, high protein yoghurts and quarks, and high protein food bars.

High protein confectionary products, such as food bars, often include dairy proteins; such as whey protein, casein, and/or caseinate. The taste and mouth feel of dairy proteins is generally considered neutral and pleasant.

Of the two main classes of dairy proteins—whey protein and casein—whey protein has the best nutritional value in terms of essential amino acids (especially leucine) and fast digestibility. Therefore, whey protein products are very popular for sportsmen and people with an active lifestyle.

Plant protein crops, such as legumes, are currently mainly used as animal feed. However, there is a trend towards the use of such plant proteins in human nutrition. One of the reasons for this trend is the environmental impact of these proteins compared to animal proteins like dairy, egg, and meat proteins.

Potential sources of plant proteins include soy beans, pulses (e.g. pea, chick pea, faba beans), cereals (e.g. rice), and rapeseed (e.g. canola).

As disclosed by M. Vogelsang-O'Dwyer et al., Trends in Food Science and Technology 110 (2021 ) 364-374, soy beans have a very high protein content (32-44 wt %) compared to the other plant protein sources, contain a significant amount of oil and hardly any carbohydrates. Rapeseed, although lower in protein, is also rich in oil. Pulses, have a high carbohydrate and fibre content, but are very low in fat.

Cereals like rice are much lower in protein and have a much higher carbohydrate content than pulses. In addition, cereal proteins are water insoluble and generally require hydrolysis (e.g. hydrolysed rice protein) in order to suitably apply them in food and beverages.

Confectionary masses and nutritional bars comprising plant proteins have been described before.

For instance, US 2004/170743 discloses a method for deflavoring soy proteins. Example 21 discloses a caramel composition comprising 15.5 wt % deflavored soy protein isolate. This caramel was used as the top layer of a nutritional bar.

WO 2020/064821 discloses a food composition comprising 10-20 wt % of a combination of leguminous protein, preferably a pea protein isolate, and a casein source, preferably a milk protein concentrate. The food product is intended for people having difficulty chewing or swallowing and therefore has a very low hardness and contains at least 45 wt % water.

US 2012/0294986 relates to the use of pea proteins to substitute at least part of the milk proteins in confectionary masses such as hard caramels and chocolates. Although it is indicated that the mass may contain 0.5-30 wt % pea protein, based on dry weight, the masses presented in the examples contain only a few percent pea protein.

When producing confectionary products with high plant protein content, one has to face additional challenges. The use of plant proteins, in particular pulse proteins, often results in an off-taste. The provision of a mass with pleasant consistency is a further challenge; these confectionary products are often either hard though sticky or brittle and crumbly. In addition, it has turned out to be a challenge to preserve any favourable properties during storage.

It is therefore an object of the present invention to provide a confectionary mass and a confectionary product, such as a food bar, that is high in protein content, contains plant protein, has a pleasant consistency, and an optimized set of sensory properties, such as mouthfeel and taste, thereby making it attractive for sportsman and people with an active lifestyle. It is a further object to provide a confectionary mass that can retain these properties for a significant storage period.

Plant protein sources are commercially available as protein isolates and protein concentrates.

In the present specification, a plant protein concentrate is defined as a plant protein source with 50-70 wt % plant protein, based on dry matter, the protein being essentially in non-aggregated and native state.

A plant protein isolate is defined in this specification as a plant protein source with 75-95 wt % preferably 80-90 wt % plant protein, based on dry matter, the protein being largely in denatured and aggregated state.

A native protein is defined as a protein in its properly folded and/or assembled form, which is operative and functional. It possesses all four levels of its biomolecular structure, with the secondary through quaternary structure being formed from weak interactions along the covalently bonded backbone. In a denatured protein, at least part of the weak interactions of the secondary through quaternary structure is disrupted, whereas the primary structure—i.e. the covalently bonded backbone—is still intact. A denatured protein therefore differs from a hydrolysed protein, as in the latter also the primary structure is disrupted.

The manufacture of plant protein concentrates, including pulse protein concentrates, mainly involves milling and air classification; mild conditions that do not significantly affect the protein nativity. A disadvantage of such mild conditions is their limited ability to separate protein bodies from starch granules and other seed materials, resulting in a relatively low protein content and purity and a relatively high concentration of anti-nutritional components and active enzymes.

In order to produce plant proteins, especially pulse proteins, with a higher protein content, a higher purity, and a lower content of anti-nutritional components and active enzymes, more severe treatment conditions are required, such as high or low pH, high temperatures, and/or organic solvents. These treatments tend to denature and aggregate at least part of the proteins, which explains the denatured and aggregated state of a significant part of the proteins in plant protein isolates; in particular pulse protein isolates.

An example of a commonly applied technique for producing pulse proteins is isoelectric precipitation, which involves rather severe treatments, such as heat coagulation and extraction, involving acid or alkaline pH and high temperature conditions. These treatments result in denaturation and aggregation of a large part of the proteins.

It has now been found that plant protein-based confectionary masses with a high protein content and a pleasant texture and taste can be made from a combination of a plant protein concentrate or plant protein hydrolysate and a specific type of dairy protein: microparticulated whey protein.

The invention therefore relates to a confectionary mass comprising:
10-70 wt % of a combination of at least two protein sources,
25-80 wt % of a binding material, preferably selected from carbohydrates and sugar alcohols, and
5-20 wt % of oil, preferably vegetable oil,
wherein the total water content of the confectionary mass is in the range 5-30 wt % and
wherein the combination of at least two protein sources comprises, based on dry matter, 10-50 wt % of a plant protein concentrate or plant protein hydrolysate and 50-90 wt % microparticulated whey protein.

This confectionary mass can be prepared by blending the at least two protein sources—i.e. 10-50 wt % of a plant protein concentrate or plant protein hydrolysate and 50-90 wt % microparticulated whey protein—with the binder and the oil.

Microparticulated whey protein was first described in U.S. Pat. No. 4,734,287 which formed the basis for the commercial fat replacer Simplesse®. This material was offered for use in frozen desserts, cheese, dressings, and mayonnaise, and allowed a creamy texture despite the reduced fat content. It was produced by thermal aggregation of whey protein under high shear and low pH.

There appears to be no formal definition of the term ‘microparticulated whey protein’. Furthermore, there are various other terms for this same type of material, such as: heat-denatured whey protein particles, whey protein aggregates or microparticles, and heat-stable whey. Within the present specification, the term ‘microparticulated whey protein’ is defined as whey protein concentrate (WPC) or whey protein isolate (WPI) that has been subjected to heat treatment and high shear/mechanical forces, leading to small micron-sized whey protein particles/aggregates with a high degree of denaturation.

50 vol % of the particles/aggregates of microparticulated whey protein have a particle diameter in the range 0.05-20 microns, more preferably 0.05-10 microns, most preferably 0.05-1.0 microns. Generally, 90 vol % of the particles (D90) has a diameter of less than 60 microns, more preferably less than 10 microns, most preferably less than 5.0 microns. This particle diameter and size distribution are determined, after homogenization at 100 bar, using laser diffraction (Malvern Matersizer 2000), with a refractive index of 1.47, and assuming non-spherical particles with an adsorption of 0. Microparticulated whey protein has a degree of denaturation, defined as a total percentage of native alpha-lactalbumin and native beta-lactoglobulin, not higher than 40 wt %, preferably not higher than 30 wt %, more preferably not higher than 20 wt %, even more preferably not higher than 15 wt %, even more preferably not higher than 10 wt %, and most preferably not higher than 5 wt %, based on total protein. The remaining part of the total α-lactalbumin and β-lactoglobulin content being in denatured form. The extent of α-lactalbumin denaturation is preferably at least 30%, preferably at least 40%, more preferably at least 50%, even more preferably at least 60%, and most preferably at least 70%. The extent of β-lactoglobulin denaturation is preferably at least 60%, preferably at least 70%, more preferably at least 75%, even more preferably at least 80%, and most preferably at least 85%.

The native α-lactalbumin and β-lactoglobulin content can be determined by means of high pressure gel permeation liquid chromatography, as described by C. Holt et al., Int. J. Food Sci. Techn. 34 (1999 ) 543-556, method 1 of BDI laboratory 1. To this end, the protein sample is dissolved in distilled water at approximately 2 g/l and the pH of the solution is adjusted to pH 4.6 with 0.5 M HCl. After 0.5 hour standing at ambient temperature, the sample is filtered using a 0.45 μm membrane and subsequently separated using a size exclusion (TSK G2000 SEXL) column, a pH 6.0 phosphate buffer, and detection at 280 nm. The concentration of native β-lactoglobulin and α-lactalbumin is determined by integration of the peak area. By comparing these concentrations with those of the starting whey protein material, the degree of denaturation can be calculated.

Whey protein concentrates (WPC) and whey protein isolates (WPI) are the result of separating skimmed milk into a casein-rich and a whey protein-rich fraction; either by renneting/cheese production (leading to cheese whey), acidification/caseinate production (leading to acid whey), or microfiltration/micellar casein isolation (leading to native whey), followed by membrane filtration, precipitation, and/or ion exchange techniques in order to remove a large part of the water, lactose, and ash, thereby concentrating the whey proteins.

WPCs conventionally have a protein content (based on dry matter) of about 60-85 wt %, whereas WPIs are manufactured by removing more of the non-protein components, thereby concentrating the whey protein to about 90-95 wt % or more.

Processes for the production of WPC or WPI may involve concentrating the entire protein fraction in the raw material, but may also include a selective enrichment in a particular protein. Examples thereof as WPCs and WPIs selectively enriched in either a-lactalbumin or b-lactoglobulin.

WPC and WPI generally have a protein content, based on dry matter, in the range 60-95 wt %, and a total percentage of native alpha-lactalbumin and beta-lactoglobulin, based on total protein, of at least 50 wt %, preferably at least 60 wt %, most preferably at least 70 wt %.

The proteins in WPC and WPI are essentially in native form.

Like WPC and WPI, microparticulated whey protein preferably has a protein content, based on dry matter, of 60-95 wt %, but differs from WPC and WPI in that a large part of the proteins, especially alpha-lactalbumin and beta-lactoglobulin, is denatured.

As shown in the examples below, it appears possible to make a high protein confectionary mass with pleasant taste and mouthfeel with a combination of microparticulated whey protein and a plant protein concentrate, preferably pulse protein concentrate, as protein sources.

It is theorized that the native or hydrolysed plant (e.g. pulse) proteins better dissolve in the carbohydrate-rich mass that is used for making confectionary masses than the largely denatured whey proteins present in microparticulated whey protein. The latter will have a higher tendency to remain undissolved and absorb the syrup by acting like a kind of sponge. By applying a combination of microparticulated whey protein and plant protein concentrate, plant-based confectionary masses with a high protein content and pleasant consistency can be obtained.

In a preferred embodiment, the confectionary mass is non-caramelized, meaning that it has not been heated in order to caramelize any sugars.

In a further embodiment, the plant (e.g. pulse) protein concentrate has been submitted to a protein hydrolysis step.

The total protein content of the confectionary mass is preferably in the range 25-50 wt %, preferably 26-40 wt %, more preferably 29-38 wt %, and most preferably 32-36 wt %, based on the weight of the confectionary mass.

The protein content of the protein sources is determined using the well-known Kjeldahl nitrogen analysis method and the application of a Kjeldahl factor of 6.25 for plant proteins and 6.38 for dairy proteins.

Plant protein concentrates have a plant protein content of 50-70 wt %, based on dry matter.

Examples of suitable plant protein concentrates and hydrolysates are concentrates and hydrolysates of rice protein, wheat protein, seed protein (such as hemp protein, sunflower protein, canola protein, and pumpkin protein), and legume protein (such as soy protein and pulse proteins like faba bean protein, pea protein, lupin bean protein, mung bean protein, lentil protein, and chick pea protein), with pulse protein concentrates, more in particular faba bean protein concentrates, pea protein concentrates, chickpea protein concentrates, and combinations thereof being preferred.

In addition to the plant (e.g. pulse) protein concentrate and the microparticulated whey protein, the confectionary mass according to the invention may contain additional protein sources, such as collagen or hydrolyzed collagen, or dairy proteins like non-denatured whey protein isolate (generally containing about 90-95 wt % whey protein, based on dry matter), non-denatured whey protein concentrate (generally containing about 60-80 wt % whey protein, based on dry matter), milk protein concentrate (generally containing about 16 wt % whey protein and about 64 wt % micellar casein based on dry weight), micellar casein isolate (generally containing about 9 wt % whey protein and about 81 wt % micellar casein based on dry weight), calcium caseinate (generally containing about 90 wt % casein protein), sodium caseinate (generally containing about 90 wt % casein protein), magnesium caseinate (generally containing about 90 wt % casein protein), and hydrolysed versions of such protein sources. In a preferred embodiment, no more than 10 wt %, based on the total amount of protein in the confectionary mass, may consist of such additional protein sources, preferably no more than 5 wt %, more preferably no more than 1 wt %.

It has furthermore been found that the organoleptic properties of bars/confectionary masses that comprise a plant protein concentrate can be better preserved upon storage by including an acidulant.

It is theorized that enzymes, especially lipases and lipoxygenases, that remain active under the rather mild preparation conditions of plant protein concentrates may cause the production of off-flavours. Acidic conditions may inhibit the reactions leading to such off-flavours.

It is therefore preferred to include an acidulant in the confectionary mass.

Suitable acidulants include food-grade acids, but also compounds that may release such acids. Examples of suitable acidulants are citric acid, lactic acid, tartaric acid, acetic acid, sulphuric acid, hydrochloric acid, malic acid, fumaric acid, succinic acid, phosphoric acid, and glucono-delta-lactone (GDL). Most preferred acidulants are citric acid, malic acid, and phosphoric acid.

The acidulant is preferably present in the confectionary mass in a concentration that results in a pH of the mass below 6.0, preferably in the range 3.5-5.5, more preferably in the range 4.5-5.5, and most preferably in the range 4.5-5.5.

The acidulant may be introduced into the confectionary mass as a separate ingredient, next to the protein sources, the binding material, and the oil.

Alternatively, the acidulant is first combined with the plant (e.g. pulse) protein concentrate, which combination is then used to prepare the confectionary mass. To that end, the acidulant may be blended in powder form with the protein concentrate.

The acidulant can also be introduced into the plant (e.g. pulse) protein concentrate during an agglomeration step. This requires agglomeration of said plant protein concentrate while spraying the acidulant in liquid or dissolved form on said plant protein concentrate.

It is also possible to ferment the plant (e.g. pulse) protein concentrate with a lactic acid bacterium, e.g. Lactobacillus plantarum, thereby forming the acidulant lactic acid.

Plant protein concentrates suitable for preparing the confectionary mass of the invention preferably have the form of a powder and have a pH, when dispersed in water at a 10 wt % concentration, in the range 2.0-5.5, preferably 3.5-5.0.

The plant protein concentrate is preferably selected from the group consisting of pulse protein concentrates, more preferably from pea protein concentrates, faba bean protein concentrates, chickpea protein concentrates, and combinations thereof. The acidulant is preferably selected from the group consisting of citric acid, lactic acid, tartaric acid, acetic acid, sulphuric acid, hydrochloric acid, malic acid, fumaric acid, succinic acid, phosphoric acid, and glucono-delta-lactone (GDL), most preferably from the group consisting of citric acid, malic acid, and phosphoric acid.

Within this document, the term “powder” should be interpreted in the conventional way as solid matter in particulate, finally divided state. Powder particles may be up to about 1 mm.

The confectionary mass forms the basis of a confectionary product. The confectionary product as a whole, however, may contain one or more additional components-such as visually distinguishable phases, like as crisps or coatings-in addition to the confectionary mass. These additional components can be part of a separate layer on the (shaped) confectionary mass (e.g. a chocolate or chocolate-containing coating, a yoghurt coating), or they can be dispersed in the confectionary mass. Examples of dispersible components are fruit (concentrate) pieces, nut particles, legume particles (such as peanuts or soy, or (puffed) pieces thereof), cereal particles (e.g. cereal flakes, puffed cereals), caramel, chocolate pieces, chocolate-containing pieces, brownie pieces, protein crisps, etc.

The amount of additional components forming the confectionary product in combination with the confectionary mass is not critical. However, for a high nutritional value, the confectionary mass preferably forms 50-100 wt %, preferably 70-100 wt %, more preferably 80-100 wt %, and most preferably 90-100 wt % of the total weight of the confectionary product.

The water content of the confectionary mass should be relatively low in order to provide a non-fluid mass having at least a dough-like consistency and in order to ensure appropriate shelf-life. The water content is in the range 5-30 wt %, preferably 5-20 wt %, more preferably 10-20 wt %, based on total weight of the confectionary mass.

A confectionary product is made by shaping a confectionary mass, also referred to as a dough, into a desired form. The confectionary product and the confectionary mass are essentially solid at 20° C., meaning that they are self-supporting and essentially maintain their shape when put on a horizontal surface at atmospheric pressure (about 1 bar of air) without further support from the sides or top. The confectionary mass and product are not visibly fluid and may also be referred to as self-sustaining or dimension-stable.

Preferably, the confectionary mass and product according to the invention are self-sustaining at a temperature of 25° C., more preferably at a temperature of 30° C., in particular at a temperature of 35° C. The confectionary mass is, at least during processing, malleable, allowing it to be shaped into a desired form, such as a bar or another geometrical shape or figurine, to form a confectionary product. Such malleable mass is generally referred to in the art as a dough, or—if intended for the production of a protein bar—as a protein bar dough. The confectionary mass can thus be used as the matrix of a protein bar. Herein other food materials can be dispersed. The shaped mass can be left uncoated or form the core of a coated food product, such as a coated protein bar.

The confectionary mass according to the present invention further comprises a binding material, preferably selected from carbohydrates and sugar alcohols. Suitable binding materials are monosaccharides, disaccharides, oligosaccharides, polysaccharides, polyols, sugar alcohols, steviol glycosides, and combinations thereof. Specific examples of binding materials are glycerol, fructo-oligosaccharides (FOS), galacto-oligosaccharides (GOS), glucose-fructose syrup, tapioca syrup, maple syrup, brown rice syrup, isomaltofructose, maltitol, sorbitol, erythritol, and combinations thereof.

The binding material is present in the confectionary mass in a concentration of 25-80 wt %, more preferably 30-70 wt %, and most preferably 40-60 wt %.

The confectionary mass further contains vegetable oil. The presence of oil is desired for its effect on texture and/or mouthfeel. It acts as a plasticizer and in particular contributes to a smoother mouthfeel. Examples of suitable oils are palm oil, palm kernel oil, olive oil, rapeseed oil, sunflower oil, coconut oil, and medium chain glycerides (MCT oil). MCT oil may be a fraction of any of the above mentioned oils that is enriched in medium chain triglycerides (C6-C12). Coconut oil is a preferred oil as it is capable of providing a good taste to the confectionary product.

The oil is present in the composition in a concentration of 5-20 wt %, preferably 5 -15 wt %, most preferably 5-10 wt %.

In addition, the confectionary mass may contain flavourings, e.g. chocolate flavour, and additives like sucralose, lecithin, thickening agents (e.g. carboxymethylcellulose, xanthan gum), seeds (e.g. chia seeds), and stabilizers (e.g. carrageenan).

In addition, it may be desired to add a carbonate or bicarbonate salt, preferably sodium bicarbonate, as a processing aid.

The confectionary mass can be made in conventional ways by mixing the protein sources with the other ingredients, for instance by using a Z-blade mixer. In a preferred embodiment, the protein powders and any other solid ingredients, individually or as a blend, are added to and subsequently mixed with a liquid phase. This liquid phase usually comprises water, which may be added or be part of a carbohydrate syrup. This facilitates mixing with the protein powders when added.

The water content should be relatively low in order to provide a non-fluid mass having at least a dough-like consistency, i.e. in the range 5-30 wt. %, preferably 5-20 wt %, more preferably 10-20 wt. %, based on total ingredients. The lipid, in particular triglyceride, is usually dispersed in the liquid phase comprising water. An emulsifier is generally not needed, in particular not if the liquid phase is prepared at a temperature at which the lipid is fluid. If used, preferably lecithin is used, which has been found to have a positive effect on smoothness of the mass. The liquid phase further typically comprises the binding material (carbohydrate or sugar alcohol). Glycerol is a carbohydrate that is liquid at room or processing temperature. A binding material that is solid at room or processing temperature, or part thereof, is advantageously provided as a syrup. Such syrup may provide all the water that is desired.

The liquid phase is preferably prepared at a temperature in the range of 20-75° C., preferably 45-65° C., in particular about 60° C., or brought to a temperature in that range, after which the protein powders are mixed into the liquid phase, to obtain the confectionary mass. If desired, pieces of other food materials (e.g. nuts, chocolate, cereal, fruit) can also be added to the liquid at this stage, before, together with or after adding the protein powders.

### An Example of a Confectionary Product That Can Be Made From the Confectionary Mass is a food bar.

The confectionary mass preferably constitutes at least 50 wt %, more preferably at least 70 wt %, even more preferably at least 80 wt %, and most preferably at least 90 wt % of the weight of the confectionary product, the confectionary mass preferably either forming a matrix having other food materials dispersed therein—such as fruit (concentrate) pieces, nut particles, (puffed) legume particles, (puffed) cereal particles, caramel, chocolate pieces, chocolate-containing pieces, brownie pieces, and/or protein crisps-or forming part of a core that is a covered by a coating.

This confectionary product can be shaped in a desired form in a manner known per se. The confectionary mass can be shaped into any geometrical shape. Various shaping methods can be applied, including rolling, extruding, depositing and removing from refrigerated drums, pressing, moulding, and the like. The confectionary mass has a dough-like consistency and is non-fluid but deformable at ambient temperature, at least until after having been shaped into a desired form, such as a bar. After having been shaped, the consistency of the mass may change.

After shaping, the confectionary product may be coated, for instance with chocolate, a chocolate-containing coating, a yoghurt coating, or the like.

### EXAMPLES

### Determination of the Protein Content

The protein content of powdered plant protein sources was determined by the Kjeldahl method (N×6.25). The protein content of a powdered dairy protein source was determined by the Kjeldahl method (N×6.38).

### Example 1

A Z-blade mixer with the double-walled jacket was pre-heated to 60° C. The liquid ingredients-oil, glycerol, carbohydrate syrup-were heated to 70° C. and subsequently added to the Z-blade mixer. The protein powder(s) were added to the mixer and all ingredients were mixed at maximum speed till a cohesive dough was formed.

The resulting dough was rolled out on a tray, stored at 4° C. overnight, and cut into bars. The bars were packed individually and stored at 20° C.

The following protein powders were used:
Pea 85A—a pea protein isolate with a protein content of 79 wt % (FrieslandCampina Plantaris™ Pea Isolate)
Pea 55D—a pea protein concentrate with a protein content of 50 wt % (AGT PulsePlus™ Pea Protein 55)
Microparticulated whey protein—Fonterra Sure™ Protein 515
WPI—a whey protein isolate with a 90 wt % protein content (Nutri Whey Isolate, ex-FrieslandCampina)

The bars contained, based on dry weight, one or more plant protein powder source(s) to achieve a protein content of 35 wt % 5 wt % MCT oil, and 5 wt % glycerol; the remainder being glucose-fructose syrup. The water content was in the range 10-14 wt%.

The texture and sensory of these bars was evaluated by a group of experts; both directly after preparation (‘fresh’) and after one month of storage at room temperature (‘1 m’).

A 35 wt % protein bar with the pea protein concentrate as the sole protein source had an extremely hard texture, both after preparation and after 1 month storage, and a strong off-taste.

A bar wherein 55 wt % of the pea protein concentrate was replaced with whey protein isolate had a tough, elastic structure that was difficult to mold.

A bar wherein 55 wt % of the pea protein concentrate was replaced with microparticulated whey protein had a cohesive texture, both after preparation and after 1 month storage, and considerably better taste.

A 35 wt % protein bar with the pea protein isolate as the sole protein source had a dry an sandy texture. A bar wherein 55 wt % of the pea protein isolate was replaced with microparticulated whey protein still had a sandy, crumbly texture.

These experiments show the criticality of the combination plant protein concentrate and microparticulated whey protein for obtaining optimized properties.

1. Confectionary mass comprising:
10-70 wt % of a combination of at least two protein sources,
25-80 wt % of a binding material, preferably selected from carbohydrates and sugar alcohols, and
5-20 wt % of oil, preferably vegetable oil,
wherein the total water content of the confectionary mass is in the range 5-30 wt % and wherein the combination of at least two protein sources comprises, based on dry matter, 10-50 wt % of a plant protein concentrate or plant protein hydrolysate and 50-90 wt % microparticulated whey protein.

2. Confectionary mass according to claim 1 wherein the combination of at least two protein sources comprises, based on dry matter,
20-45 wt %, preferably 30-45 wt % of a plant protein concentrate or plant protein hydrolysate, and
55-80 wt %, preferably 55-70 wt % microparticulated whey protein.

3. Confectionary mass according to claim 1 comprising a plant protein concentrate, said plant protein concentrate being a pulse protein concentrate, preferably selected from faba bean protein concentrates, pea protein concentrates, lupin bean protein concentrates, mung bean protein concentrates, lentil protein concentrates, and chick pea protein concentrates, more preferably selected from faba bean protein concentrates, pea protein concentrates, chickpea protein concentrates, and combinations thereof.

4. Confectionary mass according to claim 1 having a total protein content in the range 25-50 wt %, preferably 26-40 wt %, more preferably 29-35 wt %, and most preferably 32-36 wt %, based on the weight of the confectionary mass.

5. Confectionary mass according to claim 1 comprising 40-60 wt % of the binding material.

6. Confectionary mass according to claim 1 additionally comprising an acidulant, preferably selected from the group consisting of citric acid, lactic acid, tartaric acid, acetic acid, sulphuric acid, hydrochloric acid, malic acid, fumaric acid, succinic acid, phosphoric acid, and glucono-delta-lactone (GDL), most preferably selected from the group consisting of citric acid, malic acid, and phosphoric acid.

7. Process for preparing a confectionary mass comprising 10-70 wt % of a combination of at least two protein sources, at least one of these protein sources being a plant protein source, 25-80 wt % of a binding material, preferably selected from carbohydrates and sugar alcohols, and 5-20 wt % of oil, preferably vegetable oil, the confectionary mass having a total water content in the range 5-30 wt %, the process comprising the step of blending the at least two protein sources with the binder and the oil, wherein the combination of at least two protein sources comprises, based on dry matter, 10-50 wt % of a plant protein concentrate or plant protein hydrolysate and 50-90 wt % microparticulated whey protein.

8. Process according to claim 7, wherein the combination of at least two protein sources comprises, based on dry matter,
20-45 wt %, preferably 30-45 wt % of a plant protein concentrate or plant protein hydrolysate, and
55-80 wt %, preferably 55-70 wt % microparticulated whey protein.

9. Process according to claim 7, wherein the combination of at least two protein sources comprises a plant protein concentrate, said plant protein concentrate being a pulse protein concentrate, preferably selected from faba bean protein concentrates, pea protein concentrates, lupin bean protein concentrates, mung bean protein concentrates, lentil protein concentrates, and chick pea protein concentrates, more preferably selected from faba bean protein concentrates, pea protein concentrates, chickpea protein concentrates, and combinations thereof.

10. Process according to claim 7 wherein the total protein content of the confectionary mass is in the range 25-50 wt %, preferably 26-40 wt %, more preferably 29-35 wt %, and most preferably 32-36 wt %, based on the weight of the confectionary mass.

11. Process according to claim 7 wherein the confectionary mass comprises 40-60 wt % of the binding material.

12. Process according to claim 7 wherein the plant protein concentrate has the form of a powder with a pH, when dispersed in water at a 10 wt % concentration, in the range 2.0-5.5, preferably 3.5-5.0, which has been obtained by acidifying a plant protein concentrate powder with an acidulant, the acidulant being preferably selected from the group consisting of citric acid, lactic acid, tartaric acid, acetic acid, sulphuric acid, hydrochloric acid, malic acid, fumaric acid, succinic acid, phosphoric acid, and glucono-delta-lactone (GDL), most preferably from the group consisting of citric acid, malic acid, and phosphoric acid.

13. Process according to claim 12 wherein the plant protein concentrate is acidified by either (i) powder blending the plant protein concentrate with the acidulant, (ii) agglomerating the plant protein concentrate while spraying the acidulant in liquid form on said plant protein concentrate, or (iii) fermenting the plant protein concentrate with a lactic acid bacterium, e.g. Lactobacillus plantarum.
